(19) United States
(12) Patent Application Publication
(10) Pub. No.: US 2025/0283303 A1
(43) Pub. Date: Sep. 11, 2025

(54) WORKING MACHINE AND METHOD OF CONTROLLING WORKING MACHINE

(71) Applicant: KUBOTA CORPORATION, Osaka (JP)

(72) Inventor: Junki ITO, Osaka (JP)

(73) Assignee: KUBOTA CORPORATION, Osaka (JP)

(21) Appl. No.: 19/220,423

(22) Filed: May 28, 2025

Related U.S. Application Data
(63) Continuation of application No. PCT/JP2023/040966, filed on Nov. 14, 2023.

(30) Foreign Application Priority Data
Dec. 28, 2022 (JP) 2022-211307

(51) Int. Cl. E02F 9/20; E02F 3/32; E02F 3/96; E02F 9/22; E02F 9/26; F15B 21/00; G07C 5/08

(52) U.S. Cl. CPC E02F 9/207; E02F 9/2004; E02F 9/26; F15B 21/00; G07C 5/0808; E02F 3/325; E02F 3/964; E02F 9/2203; E02F 9/2285; E02F 9/2292; F15B 2211/6303

(57) ABSTRACT

A working machine includes a machine body, a rotary drive source, a hydraulic device to be actuated by power generated by the rotary drive source, a working device to be actuated by a hydraulic of hydraulic fluid from the hydraulic device, a work detector to detect whether the working device is actuated, and a controller configured or programmed to, when an elapsed time period which starts when the working device enters a non-actuated state reaches a first threshold, reduce a rotational speed of the rotary drive source to a reduced rotational speed obtained by subtracting a predetermined value from a set rotational speed at a time immediately before the elapsed time period reaches the first threshold or from an actual rotational speed, and, as the elapsed time period further increases from the first threshold, reduce the rotational speed to an idling rotational speed in a stepwise or continuous manner.

### CROSS REFERENCE TO RELATED APPLICATIONS

This application is a continuation application of International Application No. PCT/JP2023/040966, filed on Nov. 14, 2023, which claims the benefit of priority to Japanese Patent Application No. 2022-211307, filed on Dec. 28, 2022. The entire contents of each of these applications are hereby incorporated herein by reference.

### BACKGROUND OF THE INVENTION

### 1. Field of the Invention

The present invention relates to working machines and methods of controlling working machines.

### 2. Description of the Related Art

For example, Japanese Unexamined Patent Application Publication No. 2021-80707 discloses an electric working machine that is driven by power of an electric motor. The electric working machine (working machine) disclosed in Japanese Unexamined Patent Application Publication No. 2021-80707 includes an electric motor that is driven by electric power that is output by a battery unit, a hydraulic pump that delivers a hydraulic fluid by being driven by the electric motor, a hydraulic device that is driven by the hydraulic fluid delivered by the hydraulic pump, a working device that is actuated by the hydraulic device, a manual operator to operate the hydraulic device, a controller that controls a rotational speed of the electric motor, and the like. The controller sets the rotational speed of the electric motor in accordance with an operation of the manual operator in a case where a value of an output current from the battery unit is equal to or greater than a predetermined value and sets the rotational speed of the electric motor to a predetermined idling rotational speed in a case where the value of the output current from the battery unit is less than the predetermined value.

### SUMMARY OF THE INVENTION

In a case where an electric motor is being driven to rotate not only in a case where the working device is performing work, but also in a case where a working device is not performing work, electric power of a battery unit is wasted, and work efficiency of a working machine decreases.

Example embodiments of the present invention make it possible to save energy of working machines.

A working machine according to an example embodiment of the present invention includes a machine body, a rotary drive source, a hydraulic device to be actuated by power generated by the rotary drive source, a working device to be actuated by a hydraulic pressure of hydraulic fluid supplied from the hydraulic device, a work detector to detect whether or not the working device is actuated, and a controller configured or programmed to, when an elapsed time period which starts when the working device enters a non-actuated state reaches a first threshold, reduce a rotational speed of the rotary drive source to a reduced rotational speed obtained by subtracting a predetermined value from a set rotational speed at a time immediately before the elapsed time period reaches the first threshold or from an actual rotational speed, and, as the elapsed time period exceeds the first threshold and further increases, reduce the rotational speed of the rotary drive source from the reduced rotational speed to an idling rotational speed in accordance with the elapsed time period in a stepwise or continuous manner.

The working machine may further include a manual operator to be operated to control the working device. The work detector may be operable to detect whether or not the working device is actuated based on the operation of the manual operator.

The working machine may further include a rotational speed operation actuator to be operated to set the set rotational speed. The controller may be configured or programmed to control the rotational speed of the rotary drive source at the set rotational speed set by operating the rotational speed operation actuator in a case that the elapsed time period is less than the first threshold, and reduce the rotational speed of the rotary drive source from the set rotational speed to the reduced rotational speed when the elapsed time period reaches the first threshold.

The working machine may further include a rotational speed detector to detect the rotational speed of the rotary drive source. The controller may be configured or programmed to, when the elapsed time period reaches the first threshold, reduce the rotational speed of the rotary drive source to the reduced rotational speed from a rotational speed of the rotary drive source detected by the rotational speed detector immediately before the elapsed time period reaches the first threshold.

The controller may be configured or programmed to, after the elapsed time period reaches the first threshold and the rotational speed of the rotary drive source is reduced to the reduced rotational speed, maintain the rotational speed of the rotary drive source at the reduced rotational speed until the elapsed time period reaches a second threshold greater than the first threshold, and, when the elapsed time period reaches the second threshold, further reduce the rotational speed of the rotary drive source from the reduced rotational speed.

The controller may be configured or programmed to reduce the rotational speed of the rotary drive source to the idling rotational speed in a stepwise or continuous manner after the elapsed time period reaches the second threshold.

The idling rotational speed may be a rotational speed of the rotary drive source for a case where the working device does not perform work, and the rotary drive source driven at the idling rotational speed may not generate enough power to cause the hydraulic device to actuate the working device.

The controller may be configured or programmed to, when the controller determines that the manual operator is operated when the elapsed time period is equal to or greater than the first threshold, control the rotational speed of the rotary drive source to the set rotational speed at a time immediately before the elapsed time period reaches the first threshold.

The rotary drive source may be an electric motor to be driven by electric power or an engine to be driven by burning fuel.

A method of controlling a working machine according to an example embodiment of the present invention is a method of controlling a working machine including a machine body, a rotary drive source, a hydraulic device to be actuated by power generated by the rotary drive source, and a working device to be actuated by a hydraulic pressure of hydraulic fluid supplied from the hydraulic device, the method including a first step including, when an elapsed time period which starts when the working device enters a non-actuated state reaches a first threshold, reducing a rotational speed of the rotary drive source to a reduced rotational speed obtained by subtracting a predetermined value from a set rotational speed at a time immediately before the elapsed time period reaches the first threshold or from an actual rotational speed, and a second step including, as the elapsed time period exceeds the first threshold and further increases, reducing the rotational speed of the rotary drive source from the reduced rotational speed to an idling rotational speed in accordance with the elapsed time period in a stepwise or continuous manner.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is an electric block diagram of a working machine.

FIG. 2 is a hydraulic circuit diagram of the working machine.

FIG. 3 illustrates a first example of a rotational speed of an electric motor in a case where auto idling control is performed.

FIG. 4 illustrates a second example of a rotational speed of an electric motor in a case where auto idling control is performed.

FIG. 5 is a view for explaining a flow of a series of processes of control of a rotational speed of the electric motor performed by a controller.

FIG. 6 is an overall side view of the working machine.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

Example embodiments of the present invention are described below with reference to the drawings.

First, an overall configuration of a working machine 1 is described.

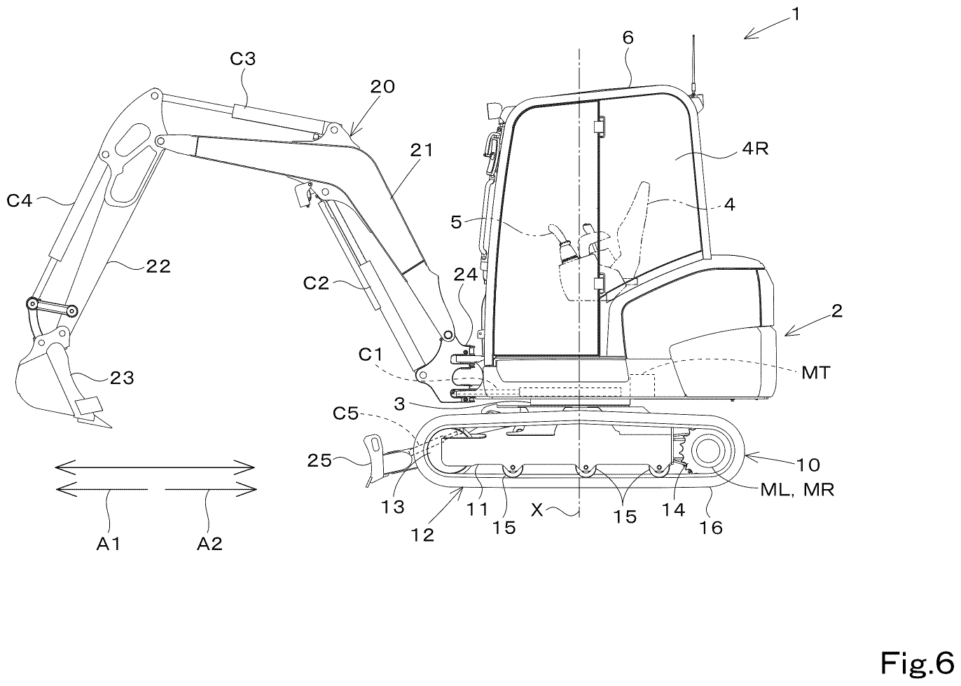

FIG. 6 is an overall side view of the working machine 1. The working machine 1 is a backhoe. In the present example embodiment, the working machine 1 is described by taking, as an example, an electric working machine that operates by electric power supplied from a battery unit 40. The working machine 1 includes a machine body (swivel base) 2, a traveling device 10, a working device 20, and the like. On the machine body 2, an operator's seat 4 on which a user sits and a protection mechanism 6 that protects the operator's seat 4 from front, rear, left, right and upper sides are provided. A manual operator 5 to operate the working machine 1 is provided around the operator's seat 4.

In the following description, a direction (a direction indicated by arrow A1 in FIG. 6) which a user sitting on the operator's seat 4 faces is referred to as a forward direction, and an opposite direction (a direction indicated by arrow A2 in FIG. 6) is referred to as a rearward direction. Furthermore, a left side viewed from a user's point of view (the near side in FIG. 6) is referred to as a leftward direction, and a right side viewed from the user's point of view (the far side in FIG. 6) is referred to as a rightward direction. A horizontal direction orthogonal to a front-rear direction (machine body front-rear direction) is referred to as a machine body width direction.

The traveling device 10 is a device that allows the machine body 2 to travel, and includes a traveling frame (truck frame) 11 and a traveling mechanism 12. The traveling frame 11 is a structure around which the traveling mechanism 12 is attached and on which the machine body 2 is supported.

The traveling mechanism 12 is, for example, a crawler-type traveling mechanism. The traveling mechanism 12 is provided on the left and right of the traveling frame 11. The traveling mechanism 12 includes an idler 13, a drive wheel 14, a plurality of track rollers 15, an endless crawler belt 16, and a traveling motor ML or MR.

The idler 13 is provided on a front portion of the traveling frame 11. The drive wheel 14 is provided on a rear portion of the traveling frame 11. The plurality of track rollers 15 are provided between the idler 13 and the drive wheel 14. The crawler belt 16 is suspended over the idler 13, the drive wheel 14, and the track rollers 15.

The left traveling motor ML is included in the traveling mechanism 12 on the left of the traveling frame 11. The right traveling motor MR is included in the traveling mechanism 12 on the right of the traveling frame 11. These traveling motors ML and MR are hydraulic motors. In each traveling mechanism 12, the drive wheel 14 is driven by power of the traveling motor ML or MR to rotate, and the crawler belt 16 thus circulates in a circumferential direction.

The machine body 2 is supported on the traveling frame 11 with a swivel bearing 3 interposed therebetween so as to be rotatable about a swivel axis X. A swivel motor MT is provided in the machine body 2. The swivel motor MT is a hydraulic motor (hydraulic actuator). The machine body 2 swivels about the swivel axis X by power of the swivel motor MT.

The working device 20 is supported on a front portion of the machine body 2. The working device 20 includes a boom 21, an arm 22, a bucket (working tool) 23, a dozer device 25, and hydraulic cylinders (hydraulic actuators) C1 to C5. A base end of the boom 21 is pivotally attached to a swing bracket 24 so as to be rotatable about a horizontal axis (an axis extending in the machine body width direction). Accordingly, the boom 21 is swingable in an up-down direction (vertical direction). The arm 22 is pivotally attached to a leading end of the boom 21 so as to be rotatable about a horizontal axis. Accordingly, the arm 22 is swingable in the front-rear direction or the up-down direction. The bucket 23 is provided on a leading end of the arm 22 so as to be capable of performing a shoveling action and a dumping action.

To the working machine 1, another working tool (hydraulic attachment) that can be driven by a hydraulic actuator can be attached instead of or in addition to the bucket 23. Examples of such a working tool include a hydraulic breaker, a hydraulic crusher, an angle broom, an earth auger, a pallet fork, a sweeper, a mower, and a snow blower.

The swing bracket 24 swings leftward and rightward by extension and contraction of the swing cylinder C1 provided in the machine body 2. The boom 21 swings upward and downward (forward and rearward) by extension and contraction of the boom cylinder C2. The arm 22 swings upward and downward (forward and rearward) by extension and contraction of the arm cylinder C3. The bucket 23 performs a shoveling action and a dumping action by extension and contraction of the bucket cylinder (working tool cylinder) C4. The swing cylinder C1, the boom cylinder C2, the arm cylinder C3, and the bucket cylinder C4 are hydraulic cylinders (hydraulic actuators).

The dozer device 25 is attached to a front portion of the traveling device 10. The dozer device 25 swings upward and downward by extension and contraction of the dozer cylinder C5. The dozer cylinder C5 is attached to the traveling frame 11. The dozer cylinder C5 is a hydraulic cylinder (hydraulic actuator).

The working machine 1 performs work while traveling by the traveling device 10 including the traveling motors ML and MR and swiveling the machine body 2 by the working device 20 including the hydraulic cylinders C1 to C5 and the swivel motor MT. That is, it can be said that not only the working device 20, but also the traveling device 10 and the swivel motor MT are working devices 20 included in the working machine 1. Hereinafter, for convenience of description, the working device 20 and the traveling device 10 are sometimes collectively referred to as “working devices 20 and 10”. Note that hydraulic actuators such as the traveling motors ML and MR, the swivel motor MT, and the hydraulic cylinders C1 to C5 are included in hydraulic devices.

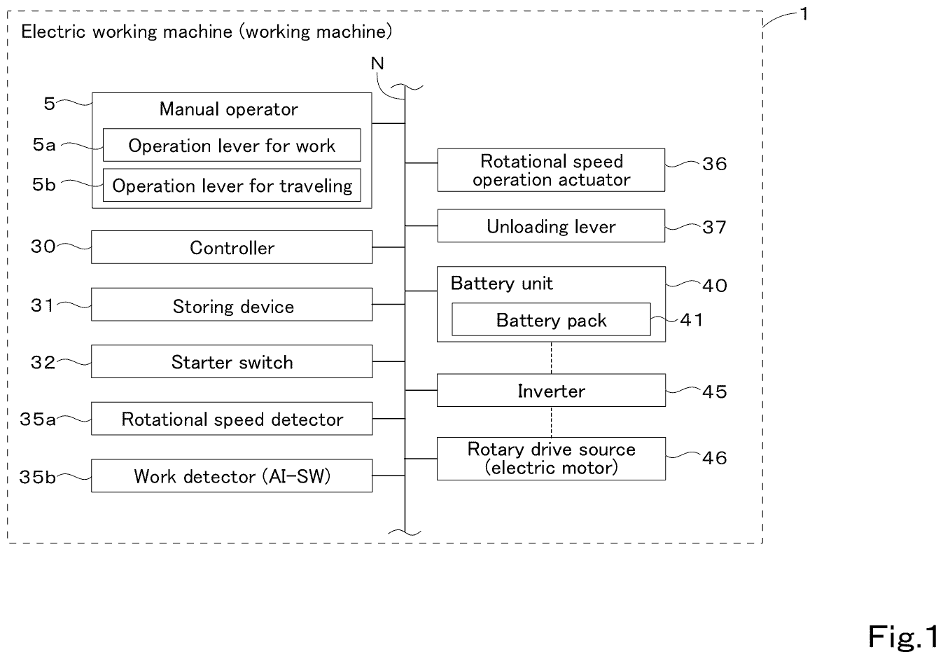

Next, an electric configuration of the working machine 1 is described. FIG. 1 is an electric block diagram of the working machine 1 according to the first example embodiment. As illustrated in FIG. 1, the working machine 1 includes a controller 30, a storing device (memory and/or storage) 31, a battery unit 40, an inverter 45, and a rotary drive source 46.

The controller 30 is provided in the machine body 2 or inside the protection mechanism 6 and is a device including an electric/electronic circuit, a CPU, a program stored in a memory, and the like. The controller 30 controls various devices connected to an in-vehicle network N of the working machine 1. The controller 30 control operation of units included in the working machine 1 such as the units illustrated in FIG. 1. For example, the controller 30 can control drive of the rotary drive source 46.

A starter switch 32 is connected to the controller 30. The starter switch 32 is provided inside the protection mechanism 6, and the user sitting on the operator's seat 4 can operate the starter switch 32. The starter switch 32 is operated to start or stop the working machine 1. The controller 30 starts each unit included in the working machine 1 in response to an ON operation of the starter switch 32 and stops each unit included in the working machine 1 in response to an OFF operation of the starter switch 32.

The storing device 31 is a recording medium such as a solid state drive (SSD) or a hard disk drive (HDD) and stores therein various kinds of information concerning the working machine 1.

The battery unit 40 is a structure that can store electric power, and discharges (outputs) the stored electric power. The battery unit 40 is mounted on the machine body 2. The battery unit 40 includes a battery pack 41. The battery pack 41 is a secondary battery (rechargeable battery) such as a lithium-ion battery including at least one battery.

The inverter 45 is electrically connected to the battery unit 40 and the electric motor 46, and converts DC electric power input from the battery unit 40 into three-phase AC electric power and supplies the three-phase AC electric power to the electric motor 46. Furthermore, the inverter 45 can freely adjust a frequency and a voltage of electric power supplied to the electric motor 46.

In the present example embodiment, the rotary drive source 46 is an electric motor that generates power by being driven by supplied electric power. The electric motor 46 receives electric power from the battery unit 40 (the battery pack 41). The electric motor 46 is electrically connected to the inverter 45 and is driven by electric power supplied from the battery unit 40 via the inverter 45. The electric motor 46 is a drive source of the working machine 1 and is, for example, a permanent magnet embedded three-phase AC synchronous motor. The electric motor 46 includes a rotor that is rotatable and a stator that generates force for rotating the rotor.

Note that the electric motor 46 may be another kind of synchronous motor, and may be AC motor or may be a DC motor.

The manual operator 5 includes an operation member for operating the working device 20. Specifically, the manual operator 5 includes operation members such as an operation lever 5a for work and an operation lever 5b for traveling. The manual operator 5 may also include a potentiometer, a switch, a sensor, or the like (not illustrated) for detecting whether or not the operation levers 5a and 5b have been operated, operation positions of the operation levers 5a and 5b, or operation amounts of the operation levers 5a and 5b.

The operation lever 5a for work is a member for operating actuation of the working device 20. The operation lever 5b for traveling is a member for operating actuation of the traveling device 10. Although the operation lever 5a for work and the operation lever 5b for traveling are each illustrated as a single block for convenience of description in FIG. 1, a plurality of operation levers 5a for work and a plurality of operation levers 5b for traveling are actually provided.

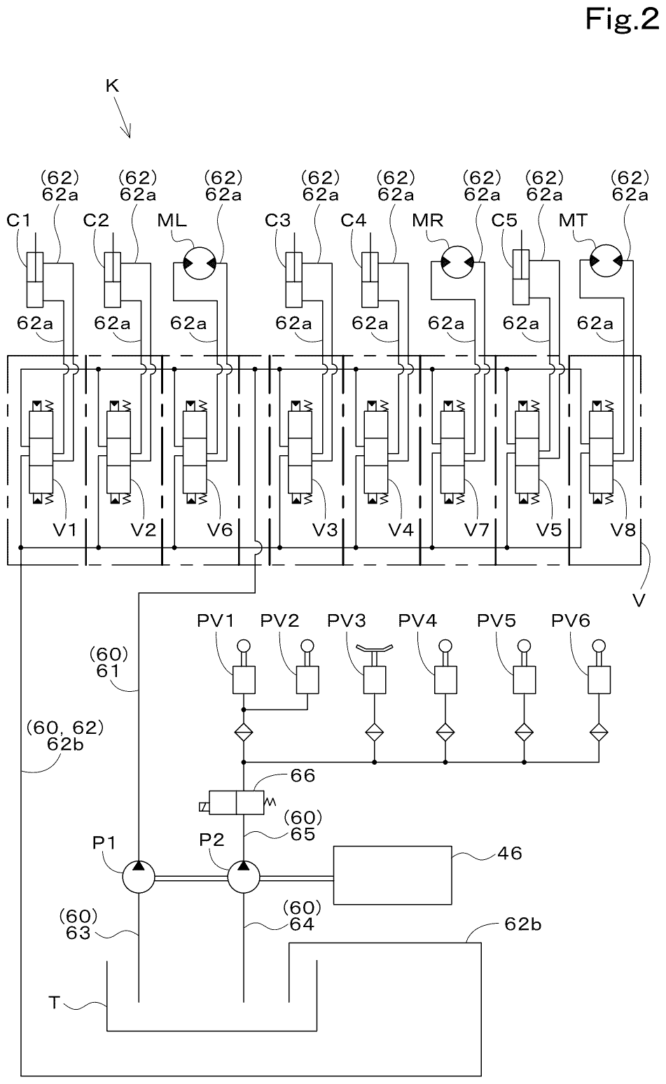

Next, a hydraulic circuit K included in the working machine 1 is described. FIG. 2 is a hydraulic circuit diagram of the working machine 1. As illustrated in FIG. 2, hydraulic devices such as the hydraulic actuators C1 to C5, ML, MR, and MT, a control valve V, hydraulic pumps P1 and P2, a hydraulic fluid tank T, operation valves PV1 to PV6, an unloading valve 66, and a fluid passage 60 are provided in the hydraulic circuit K. The hydraulic devices provided in the hydraulic circuit K of the working machine 1 are actuated by power generated by the electric motor 46. Specifically, one of the hydraulic pumps P1 and P2 is a hydraulic pump P1 for actuation, and the other one of the hydraulic pumps P1 and P2 is a hydraulic pump P2 for control. These hydraulic pumps P1 and P2 are driven by power of the electric motor 46.

The hydraulic pump P1 for actuation sucks a hydraulic fluid stored in the hydraulic fluid tank T and delivers the hydraulic fluid to the control valve V. Although a single hydraulic pump P1 for actuation is illustrated in FIG. 2 for convenience of description, this is not restrictive, and an appropriate number of hydraulic pumps P1 for actuation that supply the hydraulic fluid to the hydraulic actuators C1 to C5, ML, MR, and MT may be provided.

The hydraulic pump P2 for control outputs a hydraulic pressure for a signal, a hydraulic pressure for control, or the like by delivering the hydraulic fluid in the hydraulic fluid tank T. That is, the hydraulic pump P2 for control supplies (delivers) a pilot oil. An appropriate number of hydraulic pumps P2 for control may be provided.

The control valve V includes a plurality of controlling valves V1 to V8. The controlling valves V1 to V8 control (adjust) a flow rate of the hydraulic fluid output from the hydraulic pumps P1 and P2 to the hydraulic actuators C1 to C5, ML, MR, and MT. The swing controlling valve V1 controls a flow rate of a hydraulic fluid supplied to the swing cylinder C1. The boom controlling valve V2 controls a flow rate of a hydraulic fluid supplied to the boom cylinder C2. The arm controlling valve V3 controls a flow rate of a hydraulic fluid supplied to the arm cylinder C3. The bucket controlling valve V4 controls a flow rate of a hydraulic fluid supplied to the bucket cylinder C4. The dozer controlling valve V5 controls a flow rate of a hydraulic fluid supplied to the dozer cylinder C5. The traveling controlling valve V6 for left controls a flow rate of a hydraulic fluid supplied to the traveling motor ML on the left. The traveling controlling valve V7 for right controls a flow rate of a hydraulic fluid supplied to the traveling motor MR on the right. The swivel controlling valve V8 controls a flow rate of a hydraulic fluid supplied to the swivel motor MT.

The operation valves (remote control valves) PV1 to PV6 operate in accordance with an operation of various operation levers (the operation lever 5a for work and the operation lever 5b for traveling) included in the manual operator 5. A pilot oil acts on the controlling valves V1 to V8 in proportion to actuation amounts (operation amounts) of the operation valves PV1 to PV6, and thereby spools of the controlling valves V1 to V8 are moved. A hydraulic fluid of amounts proportional to amounts by which the spools of the controlling valves V1 to V8 are moved is supplied to the hydraulic actuators C1 to C5, ML, MR, and MT to be controlled. Furthermore, the hydraulic actuators C1 to C5, ML, MR, and MT are driven in accordance with amounts of hydraulic fluid supplied from the controlling valves V1 to V8.

In other words, by operating the operation levers 5a and 5b, the hydraulic fluid (pilot oil) that acts on the controlling valves V1 to V8 is adjusted, and thereby the controlling valves V1 to V8 are controlled. This adjusts amounts of the hydraulic fluid supplied from the controlling valves V1 to V8 to the hydraulic actuators C1 to C5, ML, MR, and MT, thereby controlling drive and stoppage of the hydraulic actuators C1 to C5, ML, MR, and MT. In this way, the working devices 20 and 10 are actuated by a hydraulic pressure of the hydraulic fluid supplied from a hydraulic device (the hydraulic pump P1).

The fluid passage 60 is a flow passage that connects units provided in the hydraulic circuit K and through which the hydraulic fluid or pilot oil flows to the units. The fluid passage 60 includes a first fluid passage 61, a second fluid passage 62, a first suction fluid passage 63, a second suction fluid passage 64, and a restriction fluid passage 65.

The first suction fluid passage 63 is a flow passage through which the hydraulic fluid sucked from the hydraulic fluid tank T by the hydraulic pump P1 for actuation flows. The second suction fluid passage 64 is a flow passage through which the hydraulic fluid sucked from the hydraulic fluid tank T by the hydraulic pump P2 for control flows.

The first fluid passage 61 is a flow passage through which the hydraulic fluid delivered by the hydraulic pump P1 for actuation flows toward the controlling valves V1 to V8 of the control valve V. The first fluid passage 61 branch into a plurality of fluid passages in the control valve V, which are connected to the controlling valves V1 to V8.

The second fluid passage 62 is a flow passage through which the hydraulic fluid that has passed the controlling valves V1 to V8 flows toward the hydraulic fluid tank T. The hydraulic fluid tank T stores the hydraulic fluid. The second fluid passage 62 includes a reciprocating fluid passage 62a and a discharge fluid passage 62b.

A plurality of reciprocating fluid passages 62a are provided so that each of the controlling valves V1 to V8 and a corresponding one of the hydraulic actuators C1 to C5, ML, MR, and MT to be controlled are connected by a pair of two reciprocating fluid passages 62a. The reciprocating fluid passages 62a are flow passages through which the hydraulic fluid is supplied from the controlling valves V1 to V8 to the hydraulic actuators C1 to C5, ML, MR, and MT and the hydraulic fluid is returned from the hydraulic actuators C1 to C5, ML, MR, and MT to the controlling valves V1 to V8. One end of the discharge fluid passage 62b branch into a plurality of discharge fluid passages, which are connected to the controlling valves V1 to V8. The other end portion of the discharge fluid passage 62b is connected to the hydraulic fluid tank T.

A part of the hydraulic fluid that has flown to any one of the controlling valves V1 to V8 through the first fluid passage 61 passes the one of the controlling valves V1 to V8, passes through one of the reciprocating fluid passages 62a, and is supplied to a corresponding one of the hydraulic actuators C1 to C5, ML, MR, and MT to be controlled. Then, the hydraulic fluid discharged from the corresponding one of the hydraulic actuators C1 to C5, ML, MR, and MT returns to the connected one of the controlling valves V1 to V8 by passing through the other one of the reciprocating fluid passages 62a, passes the one of the controlling valves V1 to V8, and flows to the discharge fluid passage 62b.

The other portion of the hydraulic fluid that has flown to any one of the controlling valves V1 to V8 by passing through the first fluid passage 61 passes the one of the controlling valves V1 to V8, flows to the discharge fluid passage 62b, and returns to the hydraulic fluid tank T without being supplied to the hydraulic actuators C1 to C5, ML, MR, and MT. As described above, the fluid passages 61, 62, and 63 are provided so that the hydraulic fluid circulates through the hydraulic fluid tank T, the hydraulic pump P1, and the controlling valves V1 to V8 of the control valve V, (a part of the hydraulic fluid also circulates through the hydraulic actuators C1 to C5, ML, MR, and MT).

The restriction fluid passage 65 is a flow passage through which the hydraulic fluid delivered by the hydraulic pump P2 for control flows to the operation valves PV1 to PV6. One end portion of the restriction fluid passage 65 is connected to the hydraulic pump P2 for control, and the other end of the restriction fluid passage 65 branches into a plurality of fluid passages, which are connected to primary-side ports (primary ports) of the operation valves PV1 to PV6.

The unloading valve 66 is provided on the restriction fluid passage 65. The unloading valve 66 prohibits drive of the hydraulic actuators C1 to C5, ML, MR, and MT, that is, drive of the working devices 20 and 10 by cutting off supply of the hydraulic fluid from the hydraulic pump P1 for actuation to the hydraulic actuators C1 to C5, ML, MR, and MT.

The unloading valve 66 is switched between a supply position and a cut-off position in accordance with an operation of an unloading lever 37. The controller 30 outputs an instruction signal to the unloading valve 66 based on an operation of the unloading lever 37, and the unloading valve 66 is thus switched between the supply position and the cut-off position. The unloading valve 66 is biased toward the cut-off position (unloading position) by a spring, and the unloading valve 66 is in the cut-off position when a solenoid is deenergized, and the unloading valve 66 is switched to the supply position when the solenoid is energized. The unloading valve 66 is energized when the unloading lever 37 is lowered, and the unloading valve 66 is deenergized by raising the unloading lever 37.

When the unloading valve 66 is switched to the supply position, the hydraulic fluid delivered from the hydraulic pump P2 for control to the restriction fluid passage 65 is supplied to the operation valves PV1 to PV6, which allows the controlling valves V1 to V8 to be operated. This also allows the hydraulic actuators C1 to C5, ML, MR, and MT, and the working devices 20 and 10 to be operated. The hydraulic fluid discharged from the operation valves PV1 to PV6 returns to the hydraulic fluid tank T by passing through another discharge fluid passage (not illustrated).

On the other hand, when the unloading valve 66 is switched to the cut-off position, the hydraulic fluid delivered from the hydraulic pump P2 for control to the restriction fluid passage 65 is discharged to the hydraulic fluid tank T and ceases to be supplied to the operation valves PV1 to PV6 (supply of the hydraulic fluid is stopped), which prohibits the controlling valves V1 to V8 from being operated. This also prohibits the hydraulic actuators C1 to C5, ML, MR, and MT, and the working devices 20 and 10 from being operated.

Although a case where the operation valves PV1 to PV6 and the controlling valves V1 to V8 are provided in the hydraulic circuit K and the operation valves PV1 to PV6 adjust a pilot oil that acts on the controlling valves V1 to V8 when the operation levers 5a and 5b are operated has been described as an example in the above example embodiment, the controlling valves V1 to V8 may adjust a hydraulic fluid that is supplied to the hydraulic actuators C1 to C5, ML, MR, and MT to be controlled based on an instruction signal from the controller 30. In this case, the controller 30 acquires an operation signal from the operation levers 5a and 5b and outputs an instruction signal to the controlling valves V1 to V8 based on the operation signal.

Next, control of the rotary drive source (electric motor) 46 performed by the controller 30 is described. The controller 30 controls a rotational speed (motor rotational speed) R of the electric motor 46 in accordance with states of a rotational speed operation actuator (accelerator dial) 36, a work detector 35b, and the unloading lever 37 during drive of the electric motor 46.

As illustrated in FIG. 1, the working machine 1 includes the rotational speed operation actuator 36. The rotational speed operation actuator 36 is an operation member for operating the motor rotational speed R. As illustrated in FIG. 1, the rotational speed operation actuator 36 is connected to the controller 30 and outputs an operation signal to the controller 30. The rotational speed operation actuator 36 is, for example, a dial-type switch such as a selector switch having a plurality of switch positions, and a target value (a set rotational speed, a target rotational speed) Rt of the motor rotational speed R is allocated to each of the plurality of switch positions. The rotational speed operation actuator 36 can set the set rotational speed Rt of the electric motor 46 within a predetermined range. In the present example embodiment, the rotational speed operation actuator 36 can be operated to set the set rotational speed Rt within a range of 1000 rpm/min to 2200 rpm/min.

Although the rotational speed operation actuator 36 is a selector switch in the above example, the rotational speed operation actuator 36 may be a pedal type, a lever type, or the like as long as at least the set rotational speed Rt can be operated. The range of the set rotational speed Rt of the electric motor 46 that is operated by the rotational speed operation actuator 36 is not limited to the range of 1000 rpm/min to 2200 rpm/min. A minimum value of the set rotational speed Rt that can be set by the rotational speed operation actuator 36 is preferably defined to a lower limit value of the rotational speed R of the electric motor 46 for performing work by the working devices 20 and 10. The lower limit value is defined to a rotational speed R of the electric motor 46 in a non-load state that can instantly actuate the working devices 20 and 10 in accordance with an operation of the operation levers 5a and 5b.

As illustrated in FIG. 1, a rotational speed detector 35a that detects an actual rotational speed (actual motor rotational speed) Ra of the electric motor 46 is connected to the controller 30, and the controller 30 controls the rotational speed R of the electric motor 46 based on the actual motor rotational speed Ra detected by the rotational speed detector 35a and the set rotational speed Rt set by the rotational speed operation actuator 36. The rotational speed detector 35a is a sensor, an encoder, a pulse generator, or the like that detects the actual motor rotational speed Ra. The controller 30 calculates the actual motor rotational speed Ra based on a detection signal input from the rotational speed detector 35a.

The controller 30 transmits an instruction signal to the inverter 45 based on the calculated actual motor rotational speed Ra and the operation signal output from the rotational speed operation actuator 36. The inverter 45 changes the motor rotational speed R of the electric motor 46 by adjusting a frequency and a voltage of electric power supplied to the electric motor 46 in accordance with the instruction signal output from the controller 30. Specifically, the controller 30 controls drive of the electric motor 46 by the inverter 45 so that the actual motor rotational speed Ra detected by the rotational speed detector 35a matches the set rotational speed Rt.

As illustrated in FIG. 1, the working machine 1 includes the work detector 35b. The work detector 35b detects whether or not the working devices 20 and 10 are working. The work detector 35b detects whether or not the working devices 20 and 10 are working based on an operation performed on the manual operator 5. In the following description, a state where the working devices 20 and 10 are actuated is referred to as an actuated state, and a state where the working devices 20 and 10 are not actuated is referred to as a non-actuated state.

In the present example embodiment, the work detector 35b is an auto idling (AI)-switch (SW) that is a pressure sensor actuated by a hydraulic pressure of the hydraulic fluid. The AI-SW 35b is in an ON state in a case where at least one of the working devices 20 and 10 is in the actuated state and is in an OFF state in a case where all of the working devices 20 and 10 are in a non-actuated state. That is, the AI-SW 35b detects whether or not the working devices 20 and 10 are working.

The AI-SW 35b is provided on an operation detection fluid passage (not illustrated) for detecting operation states of the controlling valves V1 to V8 in the hydraulic circuit K. The operation detection fluid passage is a fluid passage through which a pilot oil delivered from the hydraulic pump P2 for control sequentially passes a plurality of switch valves for switching positions of the controlling valves V1 to V8 and returns to the hydraulic fluid tank 48. The AI-SW 35b is connected to an upstream side of the controlling valve V1 provided closest to the hydraulic pump P2 for control on the operation detection fluid passage.

When any of the controlling valves V1 to V8 is operated from a neutral position to a switch position, a part of the operation detection fluid passage is cut off, and a pressure of the pilot oil in the operation detection fluid passage increases to some degree (a state where the pressure has risen). Accordingly, the AI-SW 35b is in the ON state. That is, the AI-SW 35b detects that at least one of the working devices 20 and 10 is in the actuated state. When all of the controlling valves V1 to V8 are in the neutral position, the operation detection fluid passage is open, and therefore the pressure of the pilot oil in the operation detection fluid passage does not increase to some degree (a state where the pressure has not risen). Accordingly, the AI-SW 35b is in the OFF state. That is, the AI-SW 35b detects that all of the working devices 20 and 10 are in the non-actuated state. In this way, the work detector 35b detects whether or not the working device 20 is actuated based on an operation of the manual operator 5.

Note that the work detector 35b is not limited to the AI-SW 35b provided on the operation detection fluid passage as long as the work detector 35b can detect whether or not the working device 20 is actuated, and the work detector 35b may be a potentiometer, a switch, a sensor, or the like for detecting whether or not the operation levers 5a and 5b of the manual operator 5 have been operated, operation positions of the operation levers 5a and 5b, or operation amounts of the operation levers 5a and 5b.

The controller 30 acquires a detection result of the work detector 35b during drive of the electric motor 46, and reduces the motor rotational speed R in accordance with an elapsed time period t which starts when the working device 20 enters the non-actuated state and reduces the motor rotational speed R to a predetermined idling rotational speed Ri (auto idling control). In a case where the AI-SW 35b detects an ON state, the controller 30 determines that the manual operator 5 is being operated and the working device 20 or 10 is in the actuated state. In a case where the AI-SW 35b detects an OFF state, the controller 30 determines that the manual operator 5 is not being operated and the working devices 20 and 10 are in the non-actuated state.

The controller 30 calculates, as the elapsed time period t, a period from a time at which it is determined that the manual operator 5 is not being operated in a state where the electric motor 46 is being driven. The controller 30 stores the calculated elapsed time period t in the memory. When it is determined that the manual operator 5 has been operated from the detection result of the work detector 35b, the controller 30 returns (resets) the calculated elapsed time period t to zero (t=0).

The idling rotational speed Ri is a rotational speed (motor rotational speed) R of the rotary drive source (electric motor) 46 in a state where the working device 20 is not performing work and is defined to a value less than a lower limit value Rtmin (1000 rpm/min) of the set rotational speed Rt that can be set by the rotational speed operation actuator 36. The rotary drive source (electric motor) 46 that is driven at the idling rotational speed Ri does not generate power enough to actuate the working devices 20 and 10 by the hydraulic device P1. The idling rotational speed Ri is, for example, 250 rpm/min.

Note that the idling rotational speed Ri is a rotational speed R of the electric motor 46 that can generate a hydraulic pressure of the hydraulic fluid that allows the AI-SW 35b to detect whether or not the working devices 20 and 10 are working. More specifically, the idling rotational speed Ri is defined to a rotational speed R of the electric motor 46 for generating a hydraulic pressure equal to or greater than a minimum hydraulic pressure of the hydraulic fluid that allows the AI-SW 35b to be switched to the ON state in a case where at least one of the working devices 20 and 10 is actuated and allows the AI-SW 35b to be switched to the OFF state in a case where the working devices 20 and 10 are not working.

The auto idling control performed by the controller 30 is described in detail below. When the calculated elapsed time period t reaches a first threshold t1 (t=t1), the controller 30 decreases the motor rotational speed R, and further reduces the motor rotational speed R in accordance with the elapsed time period t. That is, in a case where the elapsed time period t is less than the first threshold t1 (t<t1), the controller 30 controls the motor rotational speed R to the set rotational speed Rt set by the rotational speed operation actuator 36, and when the elapsed time period t reaches the first threshold t1 (t=t1), the controller 30 reduces the motor rotational speed R from the set rotational speed Rt set by the rotational speed operation actuator 36.

Specifically, when the elapsed time period t reaches the first threshold t1 (t=t1), the controller 30 reduces the motor rotational speed R to a reduced rotational speed Rp obtained by subtracting a predetermined value r from the set rotational speed Rt set by the rotational speed operation actuator 36 (Rp=Rt−r). The controller 30 controls the motor rotational speed R to the reduced rotational speed Rp by transmitting an instruction signal to the inverter 45 based on the calculated actual motor rotational speed Ra, an operation signal output from the rotational speed operation actuator 36, and the predetermined value r.

In a case where the elapsed time period t exceeds the first threshold t1 and further increases, the controller 30 reduces the motor rotational speed R from the reduced rotational speed Rp to the idling rotational speed Ri in accordance with the elapsed time period t in a stepwise or continuous manner. Specifically, when the elapsed time period t reaches a second threshold t2 (t=t2), the controller 30 controls the motor rotational speed R to the idling rotational speed Ri by further decreasing the motor rotational speed R. The controller 30 controls the motor rotational speed R to the idling rotational speed Ri by transmitting an instruction signal to the inverter 45 based on the calculated actual motor rotational speed Ra and the idling rotational speed Ri. The second threshold t2 is a period longer than the first threshold t1.

Note that after the elapsed time period t reaches the first threshold t1 and the motor rotational speed R is reduced to the reduced rotational speed Rp, the controller 30 maintains the motor rotational speed R at the reduced rotational speed Rp until the elapsed time period t reaches the second threshold t2. Then, the controller 30 decreases the motor rotational speed R to the idling rotational speed Ri in a stepwise or continuous manner after the elapsed time period t reaches the second threshold t2.

When it is determined that the manual operator 5 has been operated in a case where the elapsed time period t is equal to or greater than the first threshold t1, the controller 30 controls the motor rotational speed R to the set rotational speed Rt set immediately before the elapsed time period t reaches the first threshold t1.

The first threshold t1 and the second threshold t2 are, for example, predetermined values (periods) stored in advance in the storing device 31. For example, the first threshold t1 is defined to two seconds, and the second threshold t2 is defined to four seconds.

Note that these values of the first threshold t1 and the second threshold t2 are merely illustrative and are not restrictive, and for example, the first threshold t1 may be defined to three seconds and the second threshold t2 may be defined to six seconds. The first threshold t1 and/or the second threshold t2 may be changeable to any values by operating an input device (e.g., a display, not illustrated) for inputting information that is connected to the controller 30. In a case where priority is given to energy saving, the first threshold t1 and the second threshold t2 are desirably defined to short values, whereas in a case where priority is given to operability, the first threshold t1 and the second threshold t2 are desirably defined to long values. Furthermore, the first threshold t1 and/or the second threshold t2 may be changeable in accordance with the mode of the controller 30. For example, in a case where the controller 30 is switchable among a plurality of modes (e.g., an eco-mode, a normal mode, and an efficiency mode) by a mode switching switch (not illustrated) included in the manual operator 5, the first threshold t1 and/or the second threshold t2 are defined to increase in the order of the eco-mode, the normal mode, and the efficiency mode.

The predetermined value r is a constant rotational speed R defined in advance. The predetermined value r is, for example, a predetermined value (rotational speed) stored in advance in the storing device 31. The predetermined value r is defined to be less than a difference between the lower limit value Rtmin (1000 rpm/min) of the set rotational speed Rt that can be set by the rotational speed operation actuator 36 and the idling rotational speed Ri (r<Rtmin−Ri). In the present example embodiment, the predetermined value r is defined to 500 rpm/min.

Note that this value of the predetermined value r is merely illustrative and is not restrictive as long as the value of the predetermined value r is defined to be less than a difference between the lower limit value Rtmin and the idling rotational speed Ri, and may be, for example, defined to 700 rpm/min. The predetermined value r may be changeable to any value by operating an input device (e.g., a display, not illustrated) for inputting information that is connected to the controller 30. In a case where priority is given to energy saving, the predetermined value r is desirably defined to a large value, whereas in a case where priority is given to operability, the predetermined value r is desirably defined to a small value. The predetermined value r may be changeable in accordance with the mode of the controller 30, as with the first threshold t1 and/or the second threshold t2. For example, the predetermined value r is defined to decrease in the order of the eco-mode, the normal mode, and the efficiency mode. The predetermined value r may be calculated in accordance with the set rotational speed Rt set by the rotational speed operation actuator 36. The controller 30 may, for example, calculate the predetermined value r based on a predetermined arithmetic expression stored in the storing device 31 so that the value of the predetermined value r increases as the set rotational speed Rt increases.

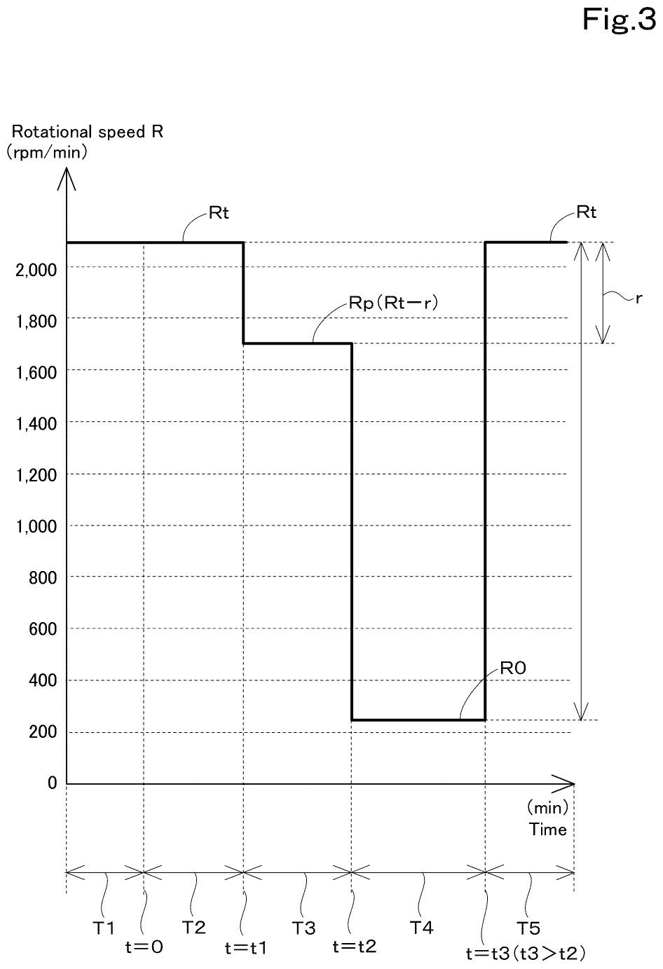

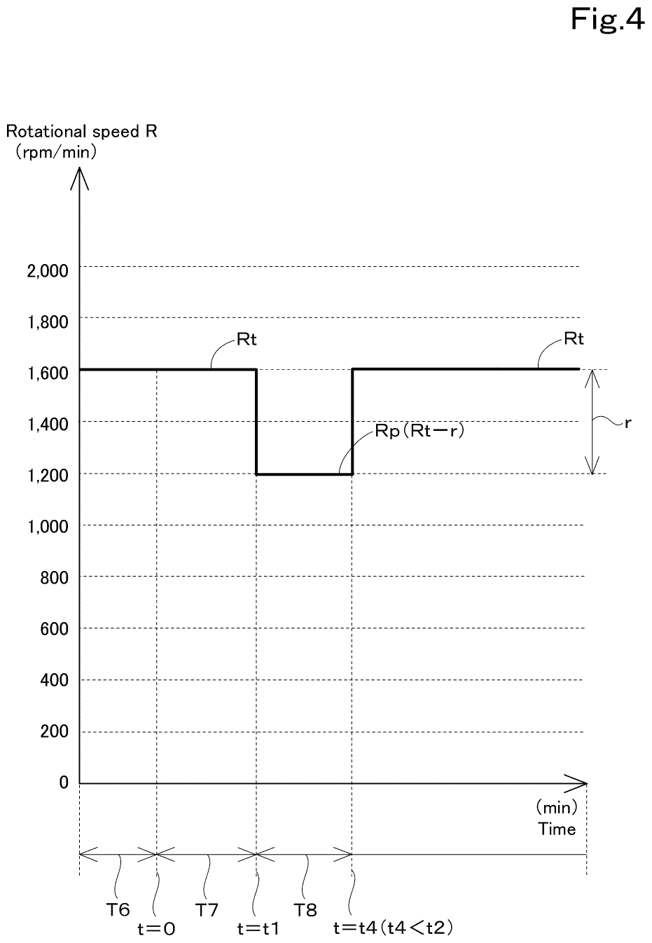

Next, a specific example of auto idling control performed by the controller 30 is described with reference to FIGS. 3 and 4. FIGS. 3 and 4 illustrate a first example and a second example of the motor rotational speed R in a case where the auto idling control is performed, respectively. In the first example illustrated in FIG. 3, a user sets the set rotational speed Rt to 2200 rpm/min by operating the rotational speed operation actuator 36. Furthermore, in the first example illustrated in FIG. 3, the user operates the manual operator 5 after the elapsed time period t exceeds the second threshold t2 (at an elapsed time period t3 illustrated in FIG. 3, t3>t2).

During a first period T1 illustrated in FIG. 3, the user is operating the manual operator 5, and the AI-SW 35b detects an ON state. Accordingly, the controller 30 determines that the manual operator 5 is being operated and any of the working devices 20 and 10 is in the actuated state. Since the elapsed time period t is zero and is less than the first threshold t1 (t=0<t1), the controller 30 controls the motor rotational speed R to the set rotational speed Rt set by the rotational speed operation actuator 36.

During a second period T2, a third period T3, and a fourth period T4 illustrated in FIG. 3, the user is not operating the manual operator 5, and the AI-SW 35b detects an OFF state. In the first example illustrated in FIG. 3, the user operates the manual operator 5 after the elapsed time period t exceeds the second threshold t2. Specifically, at the end of the fourth period T4, the user operates the manual operator 5, and the AI-SW 35b detects an ON state.

In a case where the AI-SW 35b detects an OFF state, the controller 30 determines that the manual operator 5 is not being operated and all of the working devices 20 and 10 are in the non-actuated state, and calculates the elapsed time period t. The second period T2 is a period where the elapsed time period t is longer than zero and is less than the first threshold t1 (0<t<t1), and during the second period T2, the controller 30 controls the motor rotational speed R at the set rotational speed Rt (2200 rpm/min) set by the rotational speed operation actuator 36 continuously from the first period T1.

The third period T3 is a period where the elapsed time period t is equal to or greater than the first threshold t1 and is less than the second threshold t2 (t1≤t<t2), and during the third period T3, the controller 30 controls the motor rotational speed R to the reduced rotational speed Rp by reducing the motor rotational speed R by the predetermined value r (500 rpm/min) from the set rotational speed Rt set by the rotational speed operation actuator 36. In the first example illustrated in FIG. 3, the set rotational speed Rt is set to 2200 rpm/min, and therefore the controller 30 controls the motor rotational speed R to 1700 rpm/min.

The fourth period T4 is a period from a time at which the elapsed time period t reaches the second threshold t2 to a time at which the user operates the manual operator 5 (t2≤t≤t3). During the fourth period T4, the controller 30 reduces the motor rotational speed R to the idling rotational speed Ri (250 rpm/min).

At the end of the fourth period T4 (t=t3), the AI-SW 35b detects an ON state. Accordingly, the controller 30 determines that the manual operator 5 is being operated and any of the working devices 20 and 10 is in the actuated state. Accordingly, the controller 30 resets the calculated elapsed time period t and controls the motor rotational speed R to the set rotational speed Rt (2200 rpm/min) set immediately before the elapsed time period t reaches the first threshold t1 (fifth period T5). That is, at the time of shift from the fourth period T4 to the fifth period T5, the controller 30 increases the rotational speed R by 1950 rpm/min from the idling rotational speed Ri (250 rpm/min), to which the motor rotational speed R is reduced during the fourth period T4, to the set rotational speed Rt (2200 rpm/min).

In the second example illustrated in FIG. 4, the user sets the set rotational speed Rt to 1600 rpm/min by operating the rotational speed operation actuator 36. Furthermore, in the second example illustrated in FIG. 4, the user operates the manual operator 5 after the elapsed time period t exceeds the first threshold t1 and before the elapsed time period t reaches the second threshold t2 (at an elapsed time period t4 illustrated in FIG. 4, t1<t4<t2).

During a sixth period T6 illustrated in FIG. 4, the user is operating the manual operator 5, and the elapsed time period t is zero and is less than the first threshold t1 (t=0<t1), and therefore the controller 30 controls the motor rotational speed R to the set rotational speed Rt set by the rotational speed operation actuator 36.

During a seventh period T7 and an eighth period T8 illustrated in FIG. 4, the user is not operating the manual operator 5, and the AI-SW 35b detects an OFF state. The seventh period T7 is a period where the elapsed time period t is longer than zero and is less than the first threshold t1 (0<t<t1), and during the seventh period T7, the controller 30 controls the motor rotational speed R to the set rotational speed Rt (1600 rpm/min) set by the rotational speed operation actuator 36 continuously from the sixth period T6. The eighth period T8 is a period where the elapsed time period t is equal to or greater than the first threshold t1, and ends when the user operates the manual operator 5 (t1≤t≤t4). During the eighth period T8, the controller 30 controls the motor rotational speed R to the reduced rotational speed Rp by reducing the motor rotational speed R by the predetermined value r (500 rpm/min) from the set rotational speed Rt set by the rotational speed operation actuator 36. In the second example illustrated in FIG. 4, the set rotational speed Rt is set to 1600 rpm/min, and therefore the controller 30 controls the motor rotational speed R to 1100 rpm/min.

At the end of the eighth period T8 (t=t4), the AI-SW 35b detects an ON state, and the controller 30 resets the calculated elapsed time period t and controls the motor rotational speed R to the set rotational speed Rt set immediately before the elapsed time period t reaches the first threshold t1. That is, at the time of shift from the eighth period T8, the controller 30 increases the rotational speed R by the predetermined value r (500 rpm/min) from 1100 rpm/min, which is the motor rotational speed R decreased during the eighth period T8, to the set rotational speed Rt.

As described above, in a case where the working devices 20 and 10 are in the non-actuated state and the elapsed time period t is equal to or greater than the second threshold t2, the controller 30 decreases the motor rotational speed R to the idling rotational speed Ri in two steps when the elapsed time period t reaches the first threshold t1 and when the elapsed time period t reaches the second threshold t2. That is, the controller 30 decreases the motor rotational speed R to the idling rotational speed Ri in two stages in accordance with the elapsed time period t.

Accordingly, in a case where the user does not operate the manual operator 5 and the elapsed time period t reaches the second threshold t2, the controller 30 decreases the motor rotational speed R to the idling rotational speed Ri, and therefore energy saving of the working machine 1 can be achieved. Not only energy saving can be achieved by reducing the motor rotational speed R once before the elapsed time period t reaches the second threshold t2 in a case where the elapsed time period t exceeds the first threshold t1 and further increases, but also both response and energy saving of the working machine 1 can be achieved since original work can be resumed by increasing the motor rotational speed R by the predetermined value r by the controller 30 when the manual operator 5 is operated before the elapsed time period t reaches the second threshold t2.

Note that although control in which the controller 30 decreases the motor rotational speed R to the idling rotational speed Ri in two stages in accordance with the elapsed time period t has been described as an example in the present example embodiment, the controller 30 need just decrease the motor rotational speed R when the elapsed time period t reaches the first threshold t1 and further decrease the motor rotational speed R to the idling rotational speed Ri in accordance with the elapsed time period t.

That is, the controller 30 may decrease the motor rotational speed R to the idling rotational speed Ri in three or four stages in accordance with the elapsed time period t instead of decreasing the motor rotational speed R to the idling rotational speed Ri in two stages in accordance with the elapsed time period t, and the number of stages in which the motor rotational speed R is reduced to the idling rotational speed Ri is not limited to two.

The controller 30 may control the motor rotational speed R to the reduced rotational speed Rp when the elapsed time period t reaches the first threshold t1, and decrease the motor rotational speed R successively from the reduced rotational speed Rp in accordance with the elapsed time period t such that the motor rotational speed R reaches the idling rotational speed Ri when the elapsed time period t reaches the second threshold t2.

Instead of the above idling control, the controller 30 may perform, depending on the mode, control of decreasing the motor rotational speed R from the set rotational speed Rt to the idling rotational speed Ri when the elapsed time period t reaches a predetermined threshold instead of decreasing the motor rotational speed R in a plurality of stages.

As illustrated in FIG. 1, the working machine 1 includes the unloading lever 37. The unloading lever 37 is a manual operator 5 that can be switched between a loading position (first position) where the working device 20 is permitted to work and an unloading position (second position) where the working device 20 is not permitted to work (prohibited from working). The unloading lever 37 is, for example, provided beside the operator's seat 4 so as to be swingable up and down. The unloading lever 37 closes a passage through which the user gets on to take the operator's seat 4 and gets out of the operator's seat 4 when the unloading lever 37 is swung down and is positioned in the loading position (first position, lowered position). On the other hand, the passage is opened when the unloading lever 37 is swung up and is positioned in the unloading position (second position, raised position).

When the unloading lever 37 is swung up and the unloading lever 37 is positioned in the second position during drive of the electric motor 46, the controller 30 controls the electric motor 46 to a stop rotational speed R0 (e.g., an extremely low rotational speed R such as 0 rpm/min or less than 1 rpm/min) corresponding to a stop state of the electric motor 46 irrespective of an operation of the rotational speed operation actuator 36 and idling control. The controller 30 decreases the rotational speed R of the electric motor 46 to the stop rotational speed R0 by transmitting an instruction signal to the inverter 45 based on the calculated actual motor rotational speed Ra.

Note that in a case where the unloading lever 37 is swung up and the unloading lever 37 is positioned in the second position during drive of the electric motor 46, the controller 30 may control the electric motor 46 to the idling rotational speed Ri. In this case, the controller 30 may control the electric motor 46 from the idling rotational speed Ri to the stop rotational speed R0 in a case where a predetermined period elapses from the upward swinging operation of the unloading lever 37.

Furthermore, in a case where the unloading lever 37 is swung up and the unloading lever 37 is positioned in the second position, the controller 30 may first control the electric motor 46 so that the motor rotational speed R decreases from the set rotational speed Rt set by the rotational speed operation actuator 36 by a predetermined rotational speed r′ (r′>r) higher than the predetermined value r. The predetermined rotational speed r′ is defined to be less than a difference between the lower limit value Rtmin of the set rotational speed Rt and the idling rotational speed Ri (r′<Rtmin-Ri). In this case, the controller 30 may use processing of controlling the motor rotational speed R to the idling rotational speed Ri when the elapsed time period t reaches the first threshold t1 (t=t1) and controlling the motor rotational speed R to the stop rotational speed R0 when the elapsed time period t reaches the second threshold t2 (t=t2).

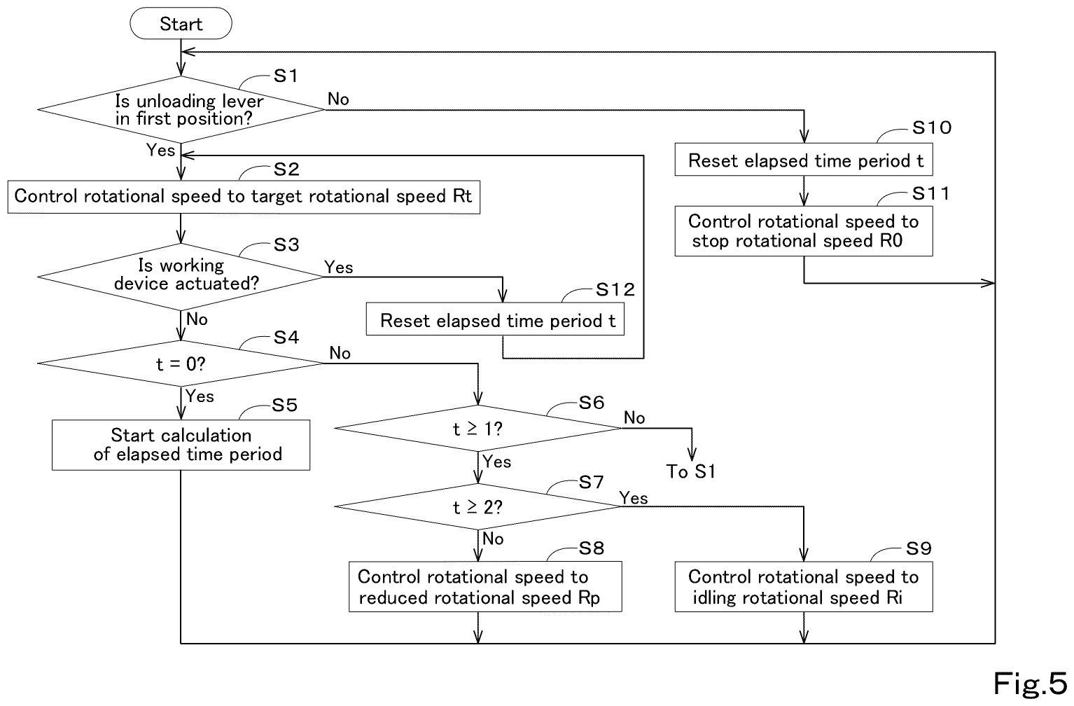

A flow of a series of processes of control of the motor rotational speed R performed by the controller 30 is described below with reference to FIG. 5. FIG. 5 is a view for explaining a flow of a series of processes of control of the motor rotational speed R performed by the controller 30. The series of processes illustrated in FIG. 5 are executed by the CPU based on a software program stored in advance in the memory of the controller 30. FIG. 5 illustrates a state where the electric motor 46 is being driven, i.e., a state where the starter switch 32 is ON, and the controller 30 starts the electric motor 46 by the inverter 45 when the starter switch 32 is turned ON by the user. During drive of the electric motor 46, the controller 30 determines whether or not the unloading lever 37 is in the first position (S1). In a case where the controller 30 determines that the unloading lever 37 is in the first position (S1, Yes), the controller 30 acquires an operation signal of the rotational speed operation actuator 36 and controls the rotational speed R of the electric motor 46 to the set rotational speed Rt (S2). Furthermore, the controller 30 determines whether or not the working devices 20 and 10 are working (S3).

In a case where the AI-SW 35b detects an OFF state and the controller 30 determines that all of the working devices 20 and 10 are in the non-actuated state (S3, No), the controller 30 determines that the elapsed time period t stored in the memory is zero (S4). In a case where the controller 30 determines that the elapsed time period t stored in the memory is zero (S4, Yes), the controller 30 starts calculation of the elapsed time period t (S5) and proceeds to S1.

In a case where the controller 30 determines that the elapsed time period t stored in the memory is not zero (S4, No), the controller 30 determines whether or not the elapsed time period t is equal to or greater than the first threshold t1 (S6). In a case where the controller 30 determines that the elapsed time period t is less than the first threshold t1 (S6, No), the controller 30 proceeds to S1.

On the other hand, in a case where the controller 30 determines that the elapsed time period t is equal to or greater than the first threshold t1 (S6, Yes), the controller 30 determines whether or not the elapsed time period t is equal to or greater than the second threshold t2 (S7). In a case where the controller 30 determines that the elapsed time period t is less than the second threshold t2 (S7, No), the controller 30 transmits an instruction signal to the inverter 45 and thus decreases the motor rotational speed R to the reduced rotational speed Rp by subtracting the predetermined value r from the set rotational speed Rt (S8, first step), and proceeds to S1.

In a case where the controller 30 determines that the elapsed time period t is equal to or greater than the second threshold t2 (S7, Yes), the controller 30 transmits an instruction signal to the inverter 45 and thus decreases the motor rotational speed R from the reduced rotational speed Rp to the idling rotational speed Ri (S9, second step), and proceeds to S1.

Note that in a case where the controller 30 determines in S1 that the unloading lever 37 is not in the first position but in the second position (S1, No), the controller 30 resets the calculated elapsed time period t (S10), transmits an instruction signal to the inverter 45 and thus controls the motor rotational speed R to the stop rotational speed R0 (S11), and proceeds to S1.

In a case where the AI-SW 35b detects an ON state and the controller 30 determines that any of the working devices 20 and 10 are in the actuated state in S3 (S3, Yes), the controller 30 resets the calculated elapsed time period t (S12), and proceeds to S2.

Note that an example in which the electric motor 46 is driven by using electric power supplied from the battery unit 40 has been described in the present example embodiment, this is not restrictive, and the electric motor 46 may be driven, for example, by using electric power supplied from an external power source.

Although an example of the electric working machine 1 including the electric motor 46 as a rotary drive source has been described in the present example embodiment, the rotary drive source is not limited to the electric motor 46. For example, the present example embodiment may be applied to a working machine including an engine (rotary drive source) such as a diesel engine or a gasoline engine instead of the electric motor 46. The present example embodiment may be also applied to a hybrid-type working machine using a combination of an electric motor (rotary drive source) and an engine (rotary drive source).

Although a configuration in which when the elapsed time period t reaches the first threshold t1, the motor rotational speed R is reduced by the predetermined value r from the target rotational speed (set rotational speed) Rt set by the rotational speed operation actuator 36 has been described in the present example embodiment, this is not restrictive. For example, when the elapsed time period t reaches the first threshold t1, the motor rotational speed R may be reduced by the predetermined value r from an actual motor rotational speed (actual rotational speed) Ra at a time immediately before the elapsed time period t detected by the rotational speed detector 35a reaches the first threshold t1. In a case where the rotary drive source is an engine, an actual rotational speed Ra of the engine may be detected by the rotational speed detector 35a, and the motor rotational speed R may be decreased by a predetermined value from the actual rotational speed Ra at a time immediately before the elapsed time period t reaches the first threshold t1.

Example embodiments of the present invention provide working machines 1 and methods of controlling working machines 1 described in the following items.

(Item 1) A working machine 1 including a machine body 2, a rotary drive source 46, a hydraulic device P1 to be actuated by power generated by the rotary drive source 46, a working device 20, 10 to be actuated by a hydraulic pressure of hydraulic fluid supplied from the hydraulic device P1, a work detector 35b to detect whether or not the working device 20, 10 is actuated, and a controller 30 configured or programmed to, when an elapsed time period t which starts when the working device 20, 10 enters a non-actuated state reaches a first threshold t1, reduce a rotational speed R of the rotary drive source 46 to a reduced rotational speed Rp obtained by subtracting a predetermined value r from a set rotational speed Rt at a time immediately before the elapsed time period t reaches the first threshold t1 or from an actual rotational speed R, and, as the elapsed time period t exceeds the first threshold t1 and further increases, reduce the rotational speed R of the rotary drive source 46 from the reduced rotational speed Rp to an idling rotational speed Ri in accordance with the elapsed time period in a stepwise or continuous manner.

With the working machine 1 according to item 1, the rotational speed R of the rotary drive source 46 is first reduced to the reduced rotational speed Rp and then further reduced to the idling rotational speed Ri, instead of reducing the rotational speed R of the rotary drive source 46 to the idling rotational speed Ri at one time. Accordingly, in a case where the elapsed time period t exceeds the first threshold t1 and further increases and the rotational speed R of the rotary drive source 46 is reduced to the idling rotational speed Ri, the energy source consumed by driving the rotary drive source 46 can be reduced, whereas in a case where the elapsed time period t is relatively short and the rotational speed R of the rotary drive source 46 has not decreased to the idling rotational speed Ri, the rotational speed R of the rotary drive source 46 can be easily increased.

(Item 2) The working machine 1 according to item 1, further including a manual operator 5 to be operated to control the working device 20, 10, wherein the work detector 35b is operable to detect whether or not the working device 20, 10 is actuated based on the operation of the manual operator 5.

With the working machine 1 according to item 2, the work detector 35b can more reliably detect whether or not the working device 20 is actuated.

(Item 3) The working machine 1 according to item 1 or 2, further including a rotational speed operation actuator 36 to be operated to set the set rotational speed Rt, wherein the controller 30 is configured or programmed to control the rotational speed R of the rotary drive source 46 at the set rotational speed Rt set by operating the rotational speed operation actuator 36 in a case that the elapsed time period t is less than the first threshold t1, and reduce the rotational speed R of the rotary drive source 46 from the set rotational speed Rt to the reduced rotational speed Rp when the elapsed time period t reaches the first threshold t1.

With the working machine 1 according to item 3, when the elapsed time period t reaches the first threshold t1, the rotational speed R of the rotary drive source 46 is reduced from the rotational speed Rt set by operating the rotational speed operation actuator 36, and therefore the energy source consumed by driving the rotary drive source 46 can be reduced without having to operate the rotational speed operation actuator 36.

(Item 4) The working machine 1 according to item 1 or 2, further including a rotational speed detector 35a to detect the rotational speed R of the rotary drive source 46, wherein the controller 30 is configured or programmed to, when the elapsed time period t reaches the first threshold t1, reduce the rotational speed R of the rotary drive source 46 to the reduced rotational speed Rp from a rotational speed R of the rotary drive source 46 detected by the rotational speed detector 35a immediately before the elapsed time period t reaches the first threshold t1.

With the working machine 1 according to item 4, when the elapsed time period t reaches the first threshold t1, the rotational speed R of the rotary drive source 46 is reduced from the rotational speed R of the rotary drive source 46 detected immediately before the elapsed time period t reaches the first threshold t1, and therefore the energy source consumed by driving the rotary drive source 46 can be reduced without having to operate the rotational speed operation actuator 36.

(Item 5) The working machine 1 according to any one of items 1 to 4, wherein the controller 30 is configured or programmed to, after the elapsed time period t reaches the first threshold t1 and the rotational speed R of the rotary drive source 46 is reduced to the reduced rotational speed Rp, maintain the rotational speed R of the rotary drive source 46 at the reduced rotational speed Rp until the elapsed time period t reaches a second threshold t2 greater than the first threshold t1, and when the elapsed time period t reaches the second threshold t2, further reduce the rotational speed R of the rotary drive source 46 from the reduced rotational speed Rp.

With the working machine 1 according to item 5, the rotational speed R of the rotary drive source 46 can be easily increased before the elapsed time period t reaches the second threshold t2, and after the elapsed time period t reaches the second threshold t2, the energy source consumed by driving the rotary drive source 46 can be further reduced.

(Item 6) The working machine 1 according to item 5, wherein the controller 30 is configured or programmed to reduce the rotational speed R of the rotary drive source 46 to the idling rotational speed Ri in a stepwise or continuous manner after the elapsed time period t reaches the second threshold t2.

With the working machine 1 according to item 6, the energy source consumed by driving the rotary drive source 46 can be reduced more reliably after the elapsed time period t reaches the second threshold t2.

(Item 7) The working machine 1 according to any one of items 1 to 6, wherein the idling rotational speed Ri is a rotational speed R of the rotary drive source 46 for a case where the working device 20, 10 does not perform work, and the rotary drive source 46 driven at the idling rotational speed Ri does not generate enough power to cause the hydraulic device P1 to actuate the working device 20, 10.

With the working machine 1 according to item 7, when the elapsed time period t reaches the second threshold t2, the energy source consumed by driving the rotary drive source 46 can be reduced more reliably, and also it is possible to eliminate or reduce the likelihood that the working device(s) 20, 10 will operate unintentionally.

(Item 8) The working machine 1 according to item 2 or according to any one of claims 3 to 7 taken in combination with item 2, wherein the controller 30 is configured or programmed to, when the controller 30 determines that the manual operator 5 is operated when the elapsed time period t is equal to or greater than the first threshold t1, control the rotational speed R of the rotary drive source 46 to the set rotational speed Rt at a time immediately before the elapsed time period t reaches the first threshold t1.

With the working machine 1 according to item 8, the rotational speed R of the rotary drive source 46 can be easily returned to the original rotational speed R.

(Item 9) The working machine 1 according to any one of items 1 to 8, wherein the rotary drive source 46 is an electric motor to be driven by electric power or an engine to be driven by burning fuel.

With the working machine 1 according to item 9, the above configuration makes it possible to reduce energy source (electric power) consumed by driving the electric motor and reduce energy source (fuel) consumed by driving the engine.

(Item 10) A method of controlling a working machine 1 including a machine body 2, a rotary drive source 46, a hydraulic device P1 to be actuated by power generated by the rotary drive source 46, and a working device 20, 10 to be actuated by a hydraulic pressure of hydraulic fluid supplied from the hydraulic device P1, the method including a first step including, when an elapsed time period t which starts when the working device 20, 10 enters a non-actuated state reaches a first threshold t1, reducing a rotational speed R of the rotary drive source 46 to a reduced rotational speed Rp obtained by subtracting a predetermined value r from a set rotational speed Rt at a time immediately before the elapsed time period t reaches the first threshold t1 or from an actual rotational speed R, and a second step including, as the elapsed time period t exceeds the first threshold t1 and further increases, reducing the rotational speed R of the rotary drive source 46 from the reduced rotational speed Rp to an idling rotational speed Ri in accordance with the elapsed time period t in a stepwise or continuous manner.

With the method for controlling a working machine 1 according to item 10, the rotational speed R of the rotary drive source 46 is first reduced to the reduced rotational speed Rp and then further reduced to the idling rotational speed Ri, instead of reducing the rotational speed R of the rotary drive source 46 to the idling rotational speed Ri at one time. Accordingly, in a case where the elapsed time period t exceeds the first threshold t1 and 5 further increases and the rotational speed R of the rotary drive source 46 is reduced to the idling rotational speed Ri, the energy source consumed by driving the rotary drive source 46 can be reduced, whereas in a case where the elapsed time period t is relatively short and the rotational speed R of the rotary drive source 46 has not decreased to the idling rotational speed Ri, the rotational speed R of the rotary drive source 46 can be easily increased.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working machine comprising:
a machine body;
a rotary drive source;
a hydraulic device to be actuated by power generated by the rotary drive source;
a working device to be actuated by a hydraulic pressure of hydraulic fluid supplied from the hydraulic device;
a work detector to detect whether or not the working device is actuated; and
a controller configured or programmed to, when an elapsed time period which starts when the working device enters a non-actuated state reaches a first threshold, reduce a rotational speed of the rotary drive source to a reduced rotational speed obtained by subtracting a predetermined value from a set rotational speed at a time immediately before the elapsed time period reaches the first threshold or from an actual rotational speed, and, as the elapsed time period exceeds the first threshold and further increases, reduce the rotational speed of the rotary drive source from the reduced rotational speed to an idling rotational speed in accordance with the elapsed time period in a stepwise or continuous manner.

2. The working machine according to claim 1, further comprising a manual operator to be operated to control the working device; wherein
the work detector is operable to detect whether or not the working device is actuated based on the operation of the manual operator.

3. The working machine according to claim 2, further comprising a rotational speed operation actuator to be operated to set the set rotational speed; wherein
the controller is configured or programmed to control the rotational speed of the rotary drive source at the set rotational speed set by operating the rotational speed operation actuator in a case that the elapsed time period is less than the first threshold, and reduce the rotational speed of the rotary drive source from the set rotational speed to the reduced rotational speed when the elapsed time period reaches the first threshold.

4. The working machine according to claim 2, further comprising a rotational speed detector to detect the rotational speed of the rotary drive source; wherein
the controller is configured or programmed to, when the elapsed time period reaches the first threshold, reduce the rotational speed of the rotary drive source to the reduced rotational speed from a rotational speed of the rotary drive source detected by the rotational speed detector immediately before the elapsed time period reaches the first threshold.

5. The working machine according to claim 1, wherein
the controller is configured or programmed to:
after the elapsed time period reaches the first threshold and the rotational speed of the rotary drive source is reduced to the reduced rotational speed, maintain the rotational speed of the rotary drive source at the reduced rotational speed until the elapsed time period reaches a second threshold greater than the first threshold; and
when the elapsed time period reaches the second threshold, further reduce the rotational speed of the rotary drive source from the reduced rotational speed.

6. The working machine according to claim 5, wherein
the controller is configured or programmed to reduce the rotational speed of the rotary drive source to the idling rotational speed in a stepwise or continuous manner after the elapsed time period reaches the second threshold.

7. The working machine according to claim 6, wherein
the idling rotational speed is a rotational speed of the rotary drive source for a case where the working device does not perform work, and the rotary drive source driven at the idling rotational speed does not generate enough power to cause the hydraulic device to actuate the working device.

8. The working machine according to claim 2, wherein
the controller is configured or programmed to, when the controller determines that the manual operator is operated when the elapsed time period is equal to or greater than the first threshold, control the rotational speed of the rotary drive source to the set rotational speed at a time immediately before the elapsed time period reaches the first threshold.

9. The working machine according to claim 1, wherein
the rotary drive source is an electric motor to be driven by electric power or an engine to be driven by burning fuel.

10. A method of controlling a working machine including a machine body, a rotary drive source, a hydraulic device to be actuated by power generated by the rotary drive source, and a working device to be actuated by a hydraulic pressure of hydraulic fluid supplied from the hydraulic device, the method comprising:
a first step including, when an elapsed time period which starts when the working device enters a non-actuated state reaches a first threshold, reducing a rotational speed of the rotary drive source to a reduced rotational speed obtained by subtracting a predetermined value from a set rotational speed at a time immediately before the elapsed time period reaches the first threshold or from an actual rotational speed; and
a second step including, as the elapsed time period exceeds the first threshold and further increases, reducing the rotational speed of the rotary drive source from the reduced rotational speed to an idling rotational speed in accordance with the elapsed time period in a stepwise or continuous manner.
